(19) United States
(12) Patent Application Publication
(10) Pub. No.: US 2012/0232995 A1
(43) Pub. Date: Sep. 13, 2012

(54) VEHICLE SALES INFORMATION PROVIDING SYSTEM AND METHOD

(75) Inventors: Tiago CASTRO, Franklin, TN (US); Mark R. Weyer, Coto De Caza, CA (US); Phil Zielasko, Brentwood, TN (US); Phillip W. O'Connor, Franklin, TN (US); Peter Clissold, Franklin, TN (US); Huy Joseph Ngo, Anaheim, CA (US); Scot James Cottick, Franklin, TN (US); Ruth Elizabeth Nolte, Brentwood, TN (US); Martin P. Hussey, Brentwood, TN (US); Chad A. Jacboby, Brentwood, TN (US); Denise Barfuss, Brentwood, TN (US); Candace Listz, Nashville, TN (US); Gautam Mazumdar, Brentwood, TN (US); Jon Brancheau, Franklin, TN (US); William Peffer, Brentwood, TN (US)

(73) Assignee: Nissan North America, Inc., Franklin, TN (US)

(21) Appl. No.: 13/044,953

(22) Filed: Mar. 10, 2011

(51) Int. Cl. G06Q 30/02; G06F 17/30

(52) U.S. Cl. 705/14.64; 705/14.49; 235/375

(57) ABSTRACT

A new vehicle sales information providing method comprises providing a new vehicle having a vehicle information disclosure sheet and machine readable indicia associated with the disclosure sheet. The indicia include coded information representing a vehicle identification code unique to the new vehicle. The method also comprises receiving the coded information at a location remote to the new vehicle, with the coded information having been obtained from captured image data representing a captured image of the indicia. The method further includes retrieving additional vehicle information based on the coded information. The additional vehicle information includes information associated with and in addition to information present on the vehicle information disclosure sheet, and the additional vehicle information is unique to the new vehicle and inapplicable to any other vehicle. Additionally, the method includes wirelessly providing to a wireless device at least additional vehicle information data representing the retrieved additional vehicle information.

### BACKGROUND

1. Field of the Invention

The present invention generally relates to a new vehicle sales information providing method. More specifically, the present invention relates to a new vehicle sales information providing method that enables a user to obtain additional information pertaining to the new vehicle based on machine readable indicia associated with a vehicle information disclosure sheet.

2. Background Information

A vehicle information disclosure sheet, which can also commonly be referred to as a Monroney sticker, is typically affixed to a side window of a new vehicle. Generally, a vehicle information disclosure sheet includes information such as the make, model and year of the vehicle, the vehicle identification number (VIN), the estimated fuel efficiency of the vehicle, a list of standard and optional features included in the vehicle, and other information pertaining to the vehicle.

When a person, such as a potential buyer, views the vehicle information disclosure sheet and wishes to obtain additional information about a specific vehicle, the potential buyer usually will need to speak to a sales representative. However, this can be time consuming, especially if a sales representative is not readily available. Also, a potential buyer may be reluctant to speak to a sales representative for fear of receiving an aggressive sales pitch. In addition, when the dealer lot is closed, no sales representatives will be present to speak with the potential buyer.

Accordingly, a need exists to more readily provide additional new vehicle information to a potential buyer.

### SUMMARY

In view of the state of the known technology, one aspect of the present invention provides a new vehicle sales information providing method. The method comprises providing a new vehicle having an associated vehicle information disclosure sheet and machine readable indicia associated with the information disclosure sheet. The machine readable indicia include coded information representing a vehicle identification code unique to the new vehicle. The method also comprises receiving the coded information at a location remote to the new vehicle, with the coded information having been obtained from captured image data representing a captured image of the machine readable indicia. The method further includes retrieving additional vehicle information based on the coded information obtained from the received captured image data. The additional vehicle information includes information associated with and in addition to information present on the vehicle information disclosure sheet, and the additional vehicle information is unique to the new vehicle and inapplicable to any other vehicle. Additionally, the method includes wirelessly providing to a wireless device at least additional vehicle information data representing the retrieved additional vehicle information.

### BRIEF DESCRIPTION OF THE DRAWINGS

Referring now to the attached drawings which form a part of this original disclosure:

FIG. 1 is an exemplary block diagram of a vehicle sales information providing system according to a disclosed embodiment that provides to a user additional information pertaining to a specific vehicle;

FIG. 2 illustrates an exemplary vehicle information disclosure sheet affixed to the vehicle shown in FIG. 1, and an exemplary device for capturing an image of machine readable indicia present on the vehicle information disclosure sheet;

FIG. 3 is a detailed view of an example of the machine readable indicia present on the vehicle information disclosure sheet shown in FIGS. 1 and 2;

FIG. 4 is a detailed view of the device for capturing an image of the machine readable indicia present on the vehicle information disclosure sheet as shown in FIGS. 1 and 2;

FIG. 5 is a flow chart illustrating exemplary operations that can be performed by the vehicle sales information providing system shown in FIG. 1 to provide additional vehicle information to a user;

FIG. 6 is a flow chart illustrating exemplary operations that can be performed by the vehicle sales information providing system shown in FIG. 1 to enable a user to obtain an offer for the vehicle;

FIG. 7 is a flow chart illustrating exemplary operations that can be performed by the vehicle sales information providing system shown in FIG. 1 to enable a user to obtain a quote for the vehicle;

FIG. 8 is a flow chart illustrating exemplary operations that can be performed by the vehicle sales information providing system shown in FIG. 1 to enable a user to download additional information pertaining to the vehicle to a user device; and

FIG. 9 is a detailed view of the device shown in FIGS. 1, 2 and 4 that is operating to display additional information obtained based on information encoded in the machine readable indicia present on the vehicle information disclosure sheet as shown in FIGS. 1 and 2.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

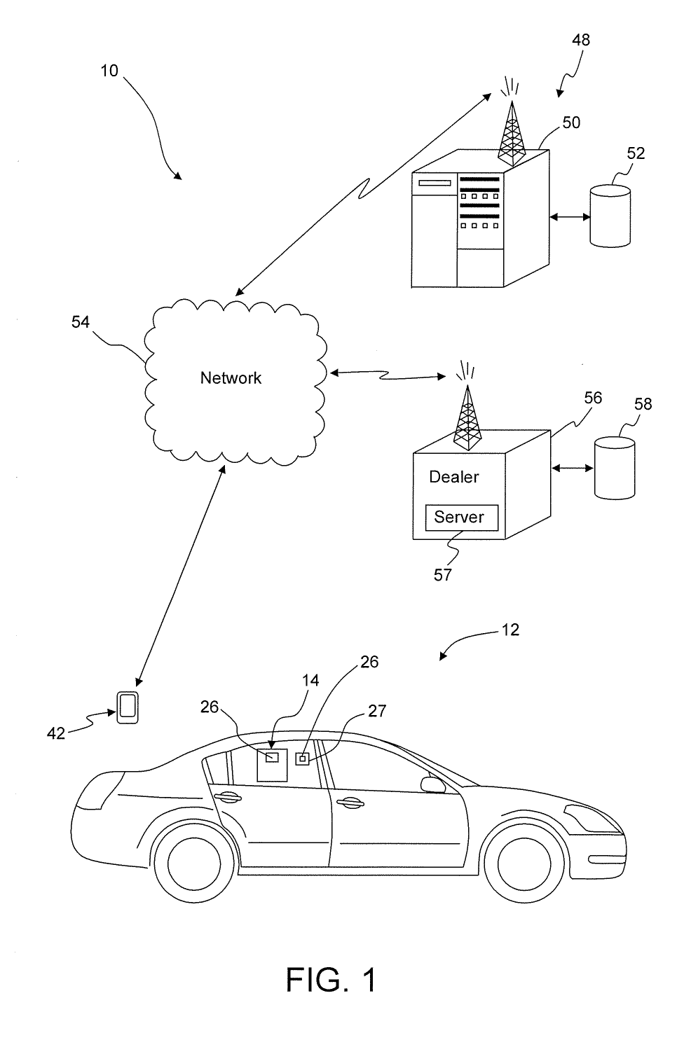

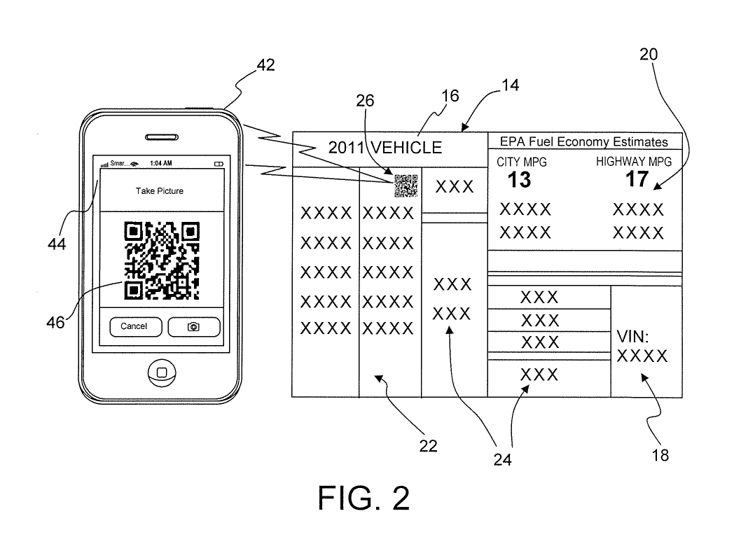

FIG. 1 illustrates an example of a vehicle sales information providing system 10 including features of a disclosed embodiment. As indicated, the system 10 includes a vehicle 12 which is, for example, a new vehicle. A vehicle information disclosure sheet 14 is affixed to the vehicle 12. Typically, the vehicle information disclosure sheet 14 is affixed to a side window of the vehicle 12 by adhesive to allow for reasonably easy removal. However, the vehicle information disclosure sheet 14 can be attached at any suitable location on the vehicle 12. The vehicle information disclosure sheet 14 can be, for example, a Monroney sticker or any other suitable document that includes information pertaining to the vehicle 12. As shown in FIG. 2, the vehicle information disclosure sheet 14 includes basic information 16 such as the make, model and year of the vehicle 12, the vehicle identification number (VIN) 18, the estimated fuel efficiency 20 of the vehicle 12, a list of standard and optional features 22 included in the vehicle 12, and other information 24 pertaining to the vehicle 12.

As further shown in FIGS. 1 and 2, machine readable indicia 26 can printed on or otherwise affixed to the vehicle information disclosure sheet 14, Alternatively, or in addition, the machine readable indicia 26 can be present on a medium 27 that is separate from the vehicle information disclosure sheet 14 and affixed to the vehicle 12. Hence, if the vehicle information disclosure sheet 14 is a Monroney sticker, the machine readable indicia 26 can be disposed on the Monroney sticker. Alternatively, or in addition, the machine readable indicia 26 can be disposed on the new vehicle 12 separate from the Monroney sticker, such as on the medium 27.

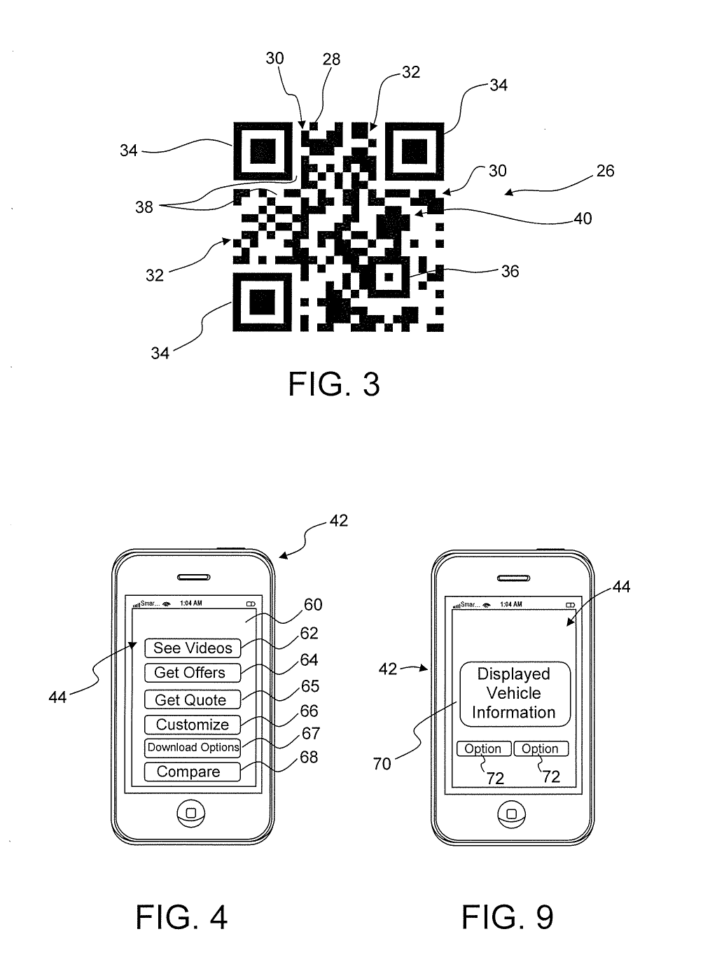

In this example, the machine readable indicia 26 includes a matrix or two-dimensional bar code, such as quick response (QR) code as known in the art. However, the machine readable indicia 26 can include any suitable configuration of indicia that represents coded information. As shown in FIG. 3, the machine readable indicia 26 in this example contains a plurality of dark sections or modules 28 arranged within a finite area, such as a square, on a light colored medium, such as a light colored portion of the vehicle information disclosure sheet 14. The modules 28 are arranged in a pattern that defines information pertaining to the machine readable indicia 26 and coded information.

For example, the modules 28 are arranged at particular locations of the machine readable indicia 26 to provide version information 30 that indicates the version of the machine readable indicia 26. The modules 28 are arranged at other particular locations of the machine readable indicia 26 to provide format information 32 that indicates the format of the machine readable indicia 26. The modules 28 are further arranged to form position patterns 34, an alignment pattern 36 and a timing pattern 38 of the machine readable indicia 26 as understood in the art. Also, the modules 28 are arranged in a data section 40 to represent an information code. The information code can include data and, for example, error correction keys as understood in the art. The data in the information code can represent information such as a uniform resource locator (URL) or any other suitable information as known in the art. Also, the information or URL can pertain to the vehicle 12 with which the machine readable indicia 26 is associated.

To read the information code, a code reader is used to capture an image of the machine readable indicia 26. A code reader can include an optical scanning device that is specifically configured to capture an image of the machine readable indicia 26 as understood in the art. Also, as shown in FIG. 1, a device 42, such as a smart phone, can include an application that configures the smart phone as a code reader. As understood by one skilled in the art, the device 42 includes a controller, such as a microcomputer, with a control program that controls and interacts with the application and components of the device 42 as discussed herein. The controller can also include other conventional components such as an input interface circuit, an output interface circuit, and storage devices such as a ROM (Read Only Memory) device and a RAM (Random Access Memory) device. The RAM and ROM store processing results and control programs that are run by the controller. The controller can be operatively coupled to the components of the device 42 in a conventional manner. It will be apparent to those skilled in the art from this disclosure that the precise structure and algorithms for the controller can be any combination of hardware and software that will carry out the functions of the embodiments discussed herein.

As shown in FIG. 2, the device 42 can be brought close enough to the machine readable indicia 26 so that the device 42 can capture an image of the machine readable indicia 26. Typically, the device 42 can use its camera features to capture the image. The device 42 can include a display 44 that displays the captured image 46 as indicated.

The device 42 can thus process the captured image in a manner known in the art to retrieve the coded information. The device 42 including the code reader can then perform the appropriate operations, such as retrieving additional information based on the coded information from a remote device 48 that is at a location remote to the vehicle 12 as shown in FIG. 1. That is, the remote device 48 can include, for example, at least one server 50 and at least one database 52, which can generally be referred to as a data storage. As understood in the art, the server 50 includes at least one controller, such as a microcomputer, with a control program that controls and interacts with the components of the server 50 as discussed herein. The controller can also include other conventional components such as an input interface circuit, an output interface circuit, and storage devices such as a ROM (Read Only Memory) device and a RAM (Random Access Memory) device. The RAM and ROM store processing results and control programs that are run by the controller. The controller can be operatively coupled to the components of the server 50 in a conventional manner. It will be apparent to those skilled in the art from this disclosure that the precise structure and algorithms for the controller can be any combination of hardware and software that will carry out the functions of the embodiments discussed herein.

As further understood in the art, the device 42 and remote device 48 can wirelessly communicate with each other via a network 54, such as a 3G or 4G network, peer-to-peer network, the Internet, and so on, using radio frequency (RF) signals or any other suitable type of signals in any suitable format, such as CMDA, TDMA, QDMA, FDMA, Bluetooth related technology, peer-to-peer transmission and so on. The database 52 can include, for example, sets of additional information that are each uniquely associated with a particular vehicle. For instance, each set of additional information can be uniquely associated with a particular VIN. In addition, the device 42, the remote device 48 and a dealer 56 who is attempting to sell the vehicle 12 can communicate with each other via the network 54.

The dealer 56 can include at least one server 57. As understood in the art, the server 57 includes at least one controller, such as a microcomputer, with a control program that controls and interacts with the components of the server 57 as discussed herein. The controller can also include other conventional components such as an input interface circuit, an output interface circuit, and storage devices such as a ROM (Read Only Memory) device and a RAM (Random Access Memory) device. The RAM and ROM store processing results and control programs that are run by the controller. The controller can be operatively coupled to the components of the server 57 in a conventional manner. It will be apparent to those skilled in the art from this disclosure that the precise structure and algorithms for the controller can be any combination of hardware and software that will carry out the functions of the embodiments discussed herein.

At least one dealer database 58 can include, for example, sets of additional information that are each uniquely associated with a particular vehicle. For instance, each set of additional information can be uniquely associated with a particular VIN. The dealer database 58 can also generally be referred to as a data storage. The database 52 and the dealer database 58 can also include vehicle information that has been provided from, for example, the Urban Science vehicle directory as understood in the automotive industry.

Accordingly, the device 42 can request the additional information pertaining to the vehicle 12 from the remote device 48 or the dealer 56 by using the VIN information included in the machine readable indicia 26 associated with the vehicle 12. Furthermore, the information in the database 52 and dealer database 58 can be updated by, for example, the dealer 56 or the new vehicle manufacturer to include information indicating which vehicles have been delivered to the dealer 56. Naturally, other dealers can update the database 52 and their own respective dealer database 58 to include information pertaining to the vehicles in their own stock. Hence, when a sale is made, the dealer 56 making the sale can update the dealer database 58, and send information to the remote device 48 via, for example, the network 54 to update the database 52 at the remote device 48 to indicate that a particular vehicle has been sold.

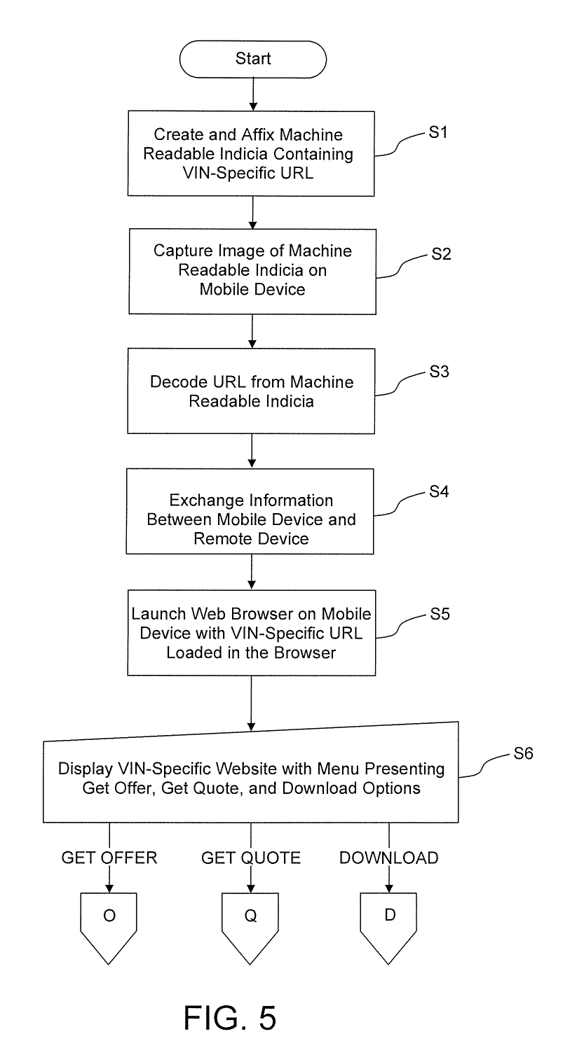

An example of a process using the device 42 that can be performed to obtain additional vehicle information is shown in FIGS. 5-8. In step S1 of the flowchart of FIG. 5, a new vehicle 12 is provided. A vehicle information disclosure sheet 14 is affixed to the new vehicle 12, and thus associated with the new vehicle 12. Also, machine readable indicia 26 associated with the vehicle information disclosure sheet 14 is provided either on the vehicle information disclosure sheet 14 itself or on another medium 27 as discussed above. The machine readable indicia 26 include coded information representing a vehicle identification code unique to the new vehicle 12. For instance, the machine readable indicia 26 can contain information pertaining to the VIN of the new vehicle 12, and VIN specific information pertaining to the vehicle 12, such as information pertaining to a vehicle specific URL.

In step S2, the device 42 is used to capture an image of the machine readable indicia 26. For instance, the device 42 can photograph the machine readable indicia 26 as discussed above. In step S3, the device 42 can decode the captured image of the machine readable indicia 26 to obtain the coded information, such as URL information for retrieving information pertaining to the vehicle 12.

In step S4, the device 42, the remote device 48 and the dealer 56 can exchange information. That is, the device 42 can send the coded information to the remote device 48 via the network 54, the dealer 56, or both in any suitable manner as discussed above. The server 50, for example, at the remote device 48 can then return information to the device 42. The information can include URL data for use by a web browser running on the device 42 in accordance with typical Internet-based operations as understood in the art. A server 57 at the dealer 56 can also send similar information, including URL data, to the device 42 via the network 54. Naturally, if the device 42 is within close proximity of the dealer 56, such as in the dealer's showroom or on the lot, the device 42 and the server 57 can wirelessly exchange information directly, such as via Bluetooth communication, ad-hoc communication, or any other direct form of communication. Also, instead of the device 42 decoding the captured image of the machine readable indicia 26 to obtain the coded information, the device 42 can send data representing the captured image to the remote device 48 and/or the dealer 56 in any of the manners discussed herein. In this case, the server 50 and/or server 57 can perform the decoding to obtain the coded information.

In step S5, the device 42 can launch a web browser, for example, with the URL information provided from the remote device 48 loaded in the web browser. Accordingly, in step S6, the device 42 can display in the display 44 a specific website 60 that is associated with the URL information, and thus associated with the vehicle 12. The specific website 60 includes, for example, a menu of buttons or links. The menu of buttons can include, for example, a See Videos button 62, a Get Offers button 64, a Get Quote button 65, a Customize button 66, a Download Options button 67 and a Compare button 68 also for downloading options, to name a few, as shown in FIG. 4.

If the user selects the See Videos button 62, the device 42 can retrieve video information pertaining to the vehicle 12 and/or related vehicles from the remote device 48 and/or the dealer 56 in any of the manners discussed above. Hence, the device 42 can play any of the videos in the browser on the display screen 44 as understood in the art. The user can also tag certain videos as favorites, save certain videos, forward videos via email, and perform any other operations relating to the videos that can typically be performed by a smart phone or other similar device.

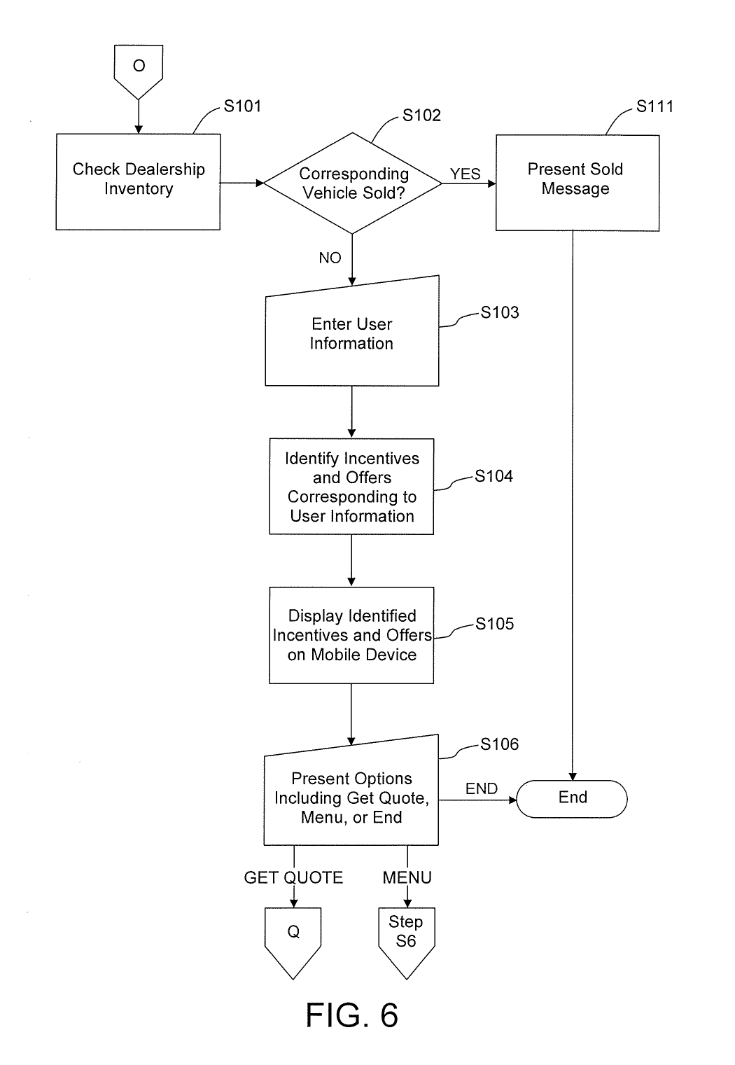

If the user selects the Get Offers button 64, the processing continues, for example, according to the flowchart shown in FIG. 6. That is, the device 42 can wirelessly transmit a message via, for example, the network 54 to remote device 48 and/or the dealer 56 to check the vehicle inventory in the database 52 or in the dealer database 58 in step S101. In step S102, the remote device 48 and/or the dealer 56 can retrieve additional vehicle information pertaining to the vehicle 12 from the database 52 and/or the dealer database 58. This retrieved additional vehicle information includes a vehicle status indicator indicating whether the new vehicle 12 is available for sale or sold. This vehicle status indicator can be commonly referred to as retail delivery registration (RDR) information. Accordingly, the remote device 48 and/or the dealer 56 can determine whether the vehicle 12 has been sold based on the retrieved additional vehicle information from the database 52 and/or the dealer database 58.

Alternatively, it should also be noted that upon receiving the exchange of information in step S4 in the flowchart of FIG. 5, the remote device 48 and/or the dealer 56 can determine whether the vehicle 12 has been sold. The information that the remote device 48 and/or the dealer 56 sends to the device 42 in step S4 can indicate whether the vehicle 12 has been sold. Hence, the device 42 can refrain from displaying the Get Offers button 64 if the vehicle 12 has been sold. In this event, the processing shown in FIG. 6 would not be performed if the vehicle 12 has been sold.

If the vehicle 12 has not been sold, the processing continues to step S103 where the device 42 can prompt the user to enter user information, such as the user's name, address including zip code, and so on, as understood in the art. The device 42 can then transmit this information to the remote device 48 and/or the dealer 56. The remote device 48 and/or the dealer 56 can determine in step S104 from information stored in the database 52 and/or the dealer database 58 whether offers or incentives corresponding to the user information are available. If any such offers or incentives are available, the remote device 48 and/or the dealer 56 can retrieve this information from, for example, the database 52 or the dealer database 58. Accordingly, in this example, the remote device 48 and/or the dealer 56 retrieves this additional vehicle information based on the coded information obtained from the received captured image data. The additional vehicle information includes information associated with and in addition to information present on the vehicle information disclosure sheet 14. The additional vehicle information is unique to the new vehicle's VIN, and thus unique to the new vehicle 12 and inapplicable to any other vehicle. That is, the retrieved additional vehicle information can include a monetary offer, and monetary incentive, or both, that are uniquely applicable to the new vehicle 12 and inapplicable to any other vehicle. The retrieved additional information can also include one or more photographs of the actual new vehicle 12 that the web browser running on the device 42 can display, for example, in a window in the display 44 of the device 42. Naturally, the photographs are information that is uniquely applicable to the new vehicle 12 and inapplicable to any other vehicle. It should also be noted that although the web site including the additional vehicle information that is displayed by the web browser running on the device 42 pertains uniquely to the new vehicle's VIN, and thus uniquely to the new vehicle 12, similar websites that pertain to other vehicles may include some identical information. For example, if the additional vehicle information includes information pertaining to a particular trim level or model level package, or a monetary offer or incentive pertaining to the trim level or model level package may also be applicable to other vehicles of similar trim levels and model levels to new vehicle 12. However, the particular additional vehicle information (e.g., the particular data) that is provided, for example, via the website to the device 42 is unique to the new vehicle 12 and inapplicable to any other vehicle.

The remote device 48 and/or the dealer 56 can thus use the network 54 to wirelessly provide to the device 42 the additional vehicle information data representing the retrieved additional vehicle information to the device 42. As discussed above, this additional vehicle information data can include information pertaining to those offers or incentives relating to the vehicle 12. Also, the additional vehicle information data can include a uniform resource locator (URL) to enable the browser running on the device 42 to access the retrieved additional vehicle information as understood in the art.

Accordingly, in step S105, the device 42 can display the information pertaining to the offers or incentives on the display 44 as displayed vehicle information 70 as shown in FIG. 9. The displayed vehicle information 70 can also include a list of multiple offers for the new vehicle 12, a list of offers for similar vehicles, a list of offers to other consumers for similar vehicles, and any other offer related information. In step S106, upon viewing the displayed information 70 pertaining to offers or incentives, the user can control the device 42 to return to the main menu to display menu buttons as shown in FIG. 4, select the Get Quote button 65 to choose to receive a quote, or exit the browser.

Also, upon return to the main menu as shown in FIG. 4, if the user selects the Customize button 66, the device 42 can display options or user prompts in the displayed vehicle information 70 as shown in FIG. 9. For instance, the displayed vehicle information 70 can include pictures and descriptions of accessories and options that are available for the vehicle 12. The displayed vehicle information 70 can also include information pertaining to the security, safety, etc. of the vehicle 12, as well as maintenance package information, and so on. The user can thus select any of the displayed items to be added to the vehicle 12. The user can thus control the device 42 to convey these selections to the dealer 56 via the network 54, email, telephone, web access and so on as understood in the art and discussed herein.

If the user selects the Compare button 68 from the main menu shown in FIG. 4, the device 42 can display information that compares the vehicle 12 to, for example, other similar vehicles in the displayed vehicle information 70 as shown in FIG. 9. The user can thus control the device 42 to request additional information from dealer 56 via email, telephone, web access and so on as understood in the art and discussed herein.

Alternatively, the user can control the device 42 to end the review process, in which event the device 42 can display any normal type of home screen as understood in the art. It should also be noted that if the remote device 48 and/or the dealer 56 determines in step S102 that the vehicle 12 of interest has already been sold, the remote device 48 and/or the dealer 56 can send information to the device 42 indicating that the vehicle 12 has been sold. In this event, device 42 can display a Sold message in step S111 as the displayed vehicle information 70. Upon displaying the Sold message, the processing can end as indicated, in which event the device 42 can display any normal type of home screen as understood in the art. Alternatively, the Sold message displayed as the displayed vehicle information 70 can include links to similar new vehicles that are still available for sale.

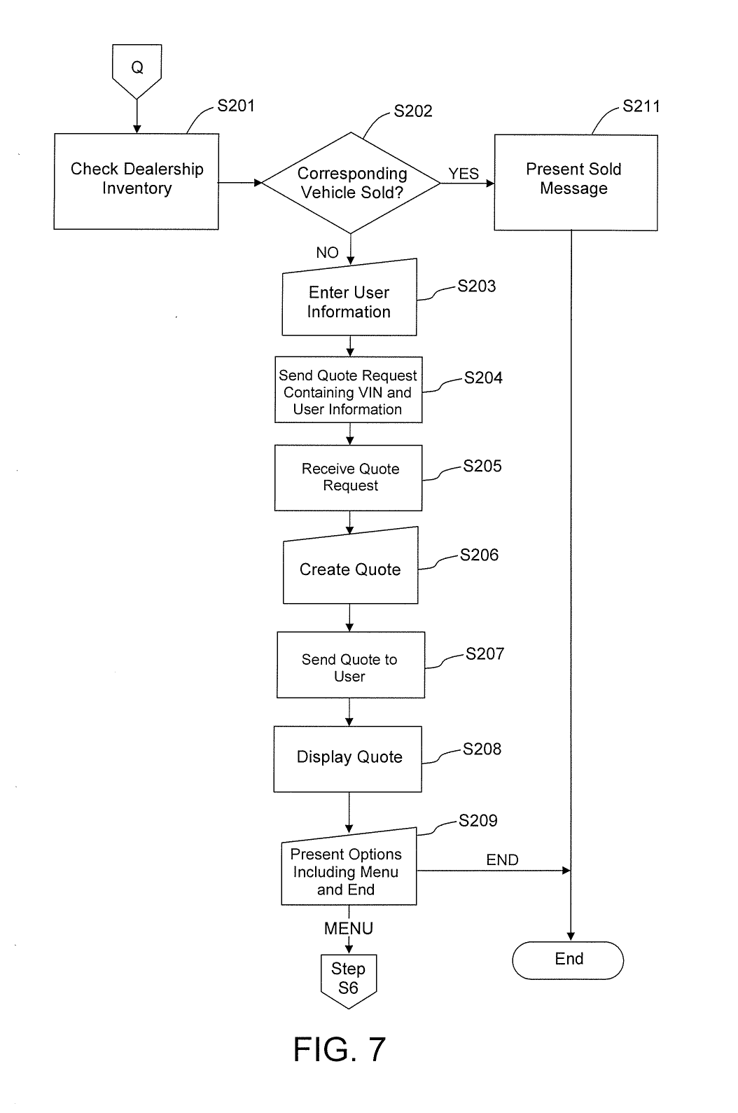

Turning back to FIG. 5, if the user selects to receive a price quote pertaining to the vehicle 12 by, for example, choosing an appropriate button or link displayed by the device 42, such as the Get Quote button 65, the processing shown in FIG. 7 can occur. That is, in step S201, the device 42 can wirelessly transmit a message via, for example, the network 54 to the remote device 48 and/or the dealer 56 to check the vehicle inventory in the database 52 and/or the dealer database 58 as in step S101 discussed above. In step S202, the remote device 48 and/or the dealer 56 can determine whether the vehicle 12 has been sold based on the information in the database 52 and/or the dealer database 58 as in step S102 discussed above. If the vehicle 12 has not been sold, the processing continues to step S203 where the device 42 can either prompt the user to enter user information, such as the user's name, address and so on, as understood in the art, or user the information that has already been entered in step S103 discussed above. For instance, the device 42 can simply prompt the user to confirm the user's information. In step S204, the device 42 can then wirelessly transmit a request for a quote to the dealer 56 via the network 54 as discussed above. The request includes, for example, the user information, the VIN associated with the vehicle 12, and any other suitable information. Naturally, if the device 42 is within close proximity of the dealer 56, such as in the dealer's showroom or on the lot, the device 42 can wirelessly transmit this information and request to the dealer 56 directly, such as via Bluetooth communication, ad-hoc communication, or any other direct form of communication.

In step S205, the dealer 56 receives the quote request, and in step S206, the dealer 56 creates the quote. The quote can be generated automatically based on, for example, information stored in a dealer database 58 that is associated with the VIN of the vehicle 12. Alternatively or in addition, dealer personnel, such as a sales associate, can enter information in the quote via, for example, a computer terminal, a smart phone and so on. In step S207, the dealer 56 sends the quote to the device 42 via, for example, the network 54 or via a direct communication as discussed above. Then, in step S208, the device 42 can display the information pertaining to the quote on the display 44 as displayed vehicle information 70 as shown in FIG. 9. Alternatively, the device 42 can present options for the user to receive the quote via email or by direct mail. In step S209, the device 42 can display option buttons 72 as shown in FIG. 9. The option buttons 72 can enable the user to, for example, control the device 42 to display menu buttons such as those shown in FIG. 4 and referred to with regard to step S6 discussed above. The option buttons 72 can also enable the user to end the quote process, in which event the device 42 can display any normal type of home screen as understood in the art.

It should also be noted that if the remote device 48 and/or the dealer 56 determines in step S202 that the vehicle 12 of interest has already been sold, the remote device 48 and/or the dealer 56 can send information to the device 42 indicating that the vehicle 12 has been sold. In this event, device 42 can display a Sold message in step S211 as the displayed vehicle information 70. Upon displaying the Sold message, the processing can end as indicated, in which event the device 42 can display any normal type of home screen as understood in the art. Alternatively, the Sold message displayed as the displayed vehicle information 70 can include links to similar new vehicles that are still available for sale.

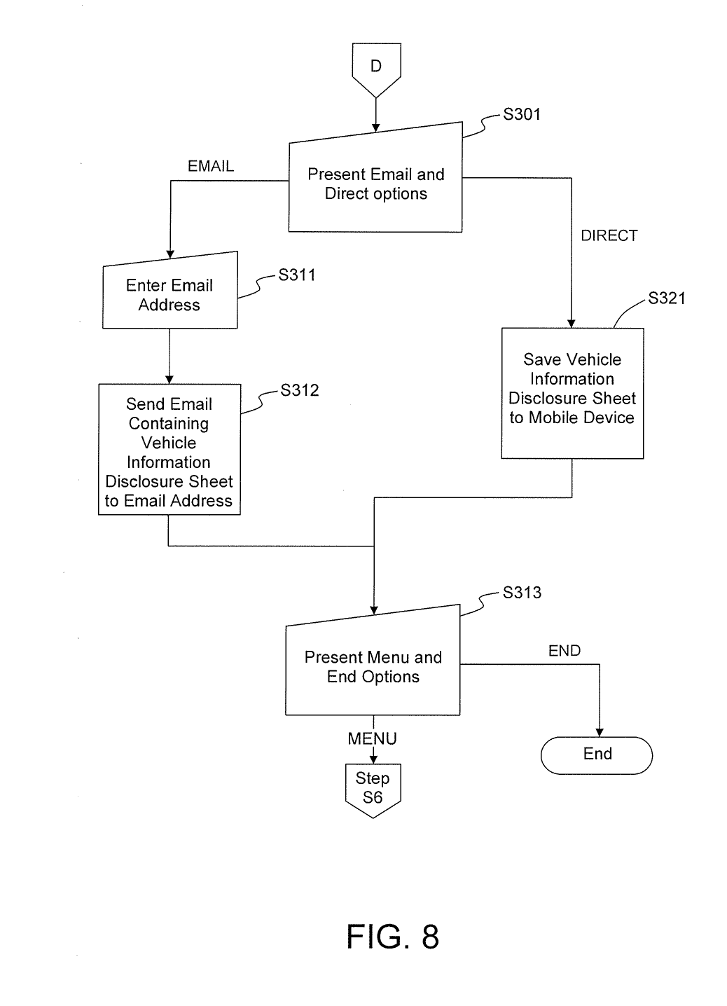

Returning to FIG. 5, if the user selects an option to download information pertaining to the vehicle 12, the processing proceeds to the flowchart shown in FIG. 8. The user can select this download option via, for example, the Customize button 66 or the Compare button 68 as shown in FIG. 4, or via the Download Options button 67 button that can be displayed on the display screen 44. In step S301 in the flowchart of FIG. 8, the device 42 can present options for the user to request the information via, for example, email or direct download. These options can be presented as option buttons such as option buttons 72 that are displayed on the display screen 44 as shown in FIG. 9. Thus, the remote device 48 and/or the dealer 56 can wirelessly provide to the device 42 vehicle information disclosure sheet data representing the information present on the vehicle information disclosure sheet 14 associated with the new vehicle 12. Hence, if the vehicle information disclosure sheet 14 is a Monroney sticker, the remote device 48 and/or the dealer 56 can wirelessly provide to the device 42 information disclosure sheet data representing the Monroney sticker.

If the user selects the email option button, the device 42 can display a prompt on the display screen 44 that requests the user to enter the user's email address in step S311. The device 42 can then send a message to the remote device 48 and/or the dealer 56 in any of the manners discussed above, such as via the network 54 or through direct communication. In step S312, the remote device 48 and/or the dealer 56 can then send an email including a data file pertaining to the vehicle information disclosure sheet 14. The data file can be included as an attachment to the email or embedded in the email. The user can then control the device 42 to store the data file, open and view the data file on the display screen 44, forward the data file to another destination via an email, and so on. In step S313, the user can control the device 42 to display menu buttons as shown in FIG. 4 according to, for example step S6 in the flowchart of FIG. 5. The user can also control the device 42 to end the review process, in which event the device 42 can display any normal type of home screen as understood in the art.

Alternatively, if the user selects the direct option button in step S301, the device 42 can send a message to the remote device 48 and/or the dealer 56 in any of the manners discussed above, such as via the network 54 or through direct communication. In step S321, the remote device 48 and/or the dealer 56 can then send a data file pertaining to the vehicle information disclosure sheet 14 in any of the manners discussed above, such as via the network 54, by direct communication and so on. The user can then control the device 42 to store the data file, open and view the data file on the display screen 44, forward the data file to another destination via an email, and so on. Then, in step S313, the user can control the device 42 to display menu buttons as shown in FIG. 4 according to, for example step S6 in the flowchart of FIG. 5. Alternatively, the user can control the device 42 to end the review process, in which event the device 42 can display any normal type of home screen as understood in the art.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also, the term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A new vehicle sales information providing method comprising:
providing a new vehicle having a vehicle information disclosure sheet associated with the new vehicle and machine readable indicia associated with the vehicle information disclosure sheet, the machine readable indicia including coded information representing a vehicle identification code unique to the new vehicle;
receiving the coded information at a location remote to the new vehicle, the coded information having been obtained from captured image data representing a captured image of the machine readable indicia;
retrieving additional vehicle information based on the coded information obtained from the received captured image data, the additional vehicle information including information associated with and in addition to information present on the vehicle information disclosure sheet, and the additional vehicle information being unique to the new vehicle and inapplicable to any other vehicle; and
wirelessly providing to a wireless device at least additional vehicle information data representing the retrieved additional vehicle information.

2. The new vehicle sales information providing method according to claim 1, wherein
the vehicle identification code includes a vehicle identification number (VIN) of the new vehicle.

3. The new vehicle sales information providing method according to claim 1, wherein
the retrieved additional vehicle information includes at least one of a monetary offer and a monetary incentive that are uniquely applicable to the new vehicle and inapplicable to any other vehicle.

4. The new vehicle sales information providing method according to claim 1, wherein
the vehicle information disclosure sheet includes a Monroney sticker; and
the machine readable indicia are disposed on the Monroney sticker.

5. The new vehicle sales information providing method according to claim 1, wherein
the vehicle information disclosure sheet includes a Monroney sticker; and
the machine readable indicia are disposed on the new vehicle separate from the Monroney sticker.

6. The new vehicle sales information providing method according to claim 1, wherein
the coded information includes a uniform resource locator (URL) to enable access to the retrieved vehicle information set.

7. The new vehicle sales information providing method according to claim 1, wherein
the retrieved additional vehicle information includes a vehicle status indicator indicating whether the new vehicle is available for sale or sold.

8. The new vehicle sales information providing method according to claim 1, further comprising
wirelessly providing to the wireless device vehicle information disclosure sheet data representing the information present on the vehicle information disclosure sheet associated with the new vehicle.

9. The new vehicle sales information providing method according to claim 8, wherein
the wirelessly providing of the vehicle information disclosure sheet data includes sending an email including the vehicle information disclosure sheet data to the wireless device.

10. A new vehicle sales information providing system comprising:
a data storage configured to store respective sets of vehicle information, each of the respective sets of vehicle information being unique to a respective new vehicle, associated with and in addition to information present on a respective vehicle information disclosure sheet associated with the respective new vehicle, and inapplicable to any other vehicle; and
a server configured to receive coded information that has been obtained from captured image data representing a captured image of machine readable indicia associated with a vehicle information disclosure sheet that is associated with one of the respective new vehicles, the machine readable indicia including the coded information representing a vehicle identification code unique to the one of the respective new vehicles, and the server being further configured to obtain the coded information and retrieve from the data storage one of the respective sets of vehicle information based on the coded information obtained from the received captured image data.

11. The new vehicle sales information providing system according to claim 10, wherein
the server is further configured to wirelessly provide to a wireless device at least vehicle information data representing the retrieved respective set of vehicle information.

12. The new vehicle sales information providing system according to claim 10, wherein
the vehicle identification code includes a vehicle identification number (VIN) of the new vehicle.

13. The new vehicle sales information providing system according to claim 10, wherein
the retrieved respective set of vehicle information includes at least one of a monetary offer and a monetary incentive that are uniquely applicable to the new vehicle and inapplicable to any other vehicle.

14. The new vehicle sales information providing system according to claim 10, wherein
the vehicle information disclosure sheet includes a Monroney sticker; and
the machine readable indicia are disposed on the Monroney sticker.

15. The new vehicle sales information providing system according to claim 10, wherein
the vehicle information disclosure sheet includes a Monroney sticker; and
the machine readable indicia are disposed on the new vehicle separate from the Monroney sticker.

16. The new vehicle sales information providing system according to claim 10, wherein
the coded information includes a uniform resource locator (URL) to enable access to the retrieved respective set of vehicle information.

17. The new vehicle sales information providing system according to claim 10, wherein
the retrieved respective set of vehicle information includes a vehicle status indicator indicating whether the new vehicle is available for sale or sold.

18. The new vehicle sales information providing system according to claim 11, wherein
the server is further configured to wirelessly provide to the wireless device vehicle information disclosure sheet data representing the information present on the vehicle information disclosure sheet associated with the new vehicle.

19. A new vehicle sales information providing method comprising:
operating a wireless device to capture an image of machine readable indicia associated with a Monroney sticker that is associated with a new vehicle, the machine readable indicia including coded information representing a vehicle identification code unique to the new vehicle;
operating the wireless device to obtain, from a location remote from the new vehicle based on the coded information, additional vehicle information based on the coded information represented by the captured image, the additional vehicle information including information associated with and in addition to information present on the Monroney sticker, and the additional vehicle information being unique to the new vehicle and inapplicable to any other vehicle; and
operating the wireless device to present the additional vehicle information to a user.

20. The new vehicle sales information providing method according to claim 19, wherein
the additional vehicle information includes at least one of a monetary offer and a monetary incentive that are uniquely applicable to the new vehicle and inapplicable to any other vehicle.
